(19) United States
(12) Patent Application Publication
(10) Pub. No.: US 2006/0145404 A1
(43) Pub. Date: Jul. 6, 2006

(54) Resilient insert for upholstery

(75) Inventor: Steen Ostergaard, Nice (FR)

Correspondence Address: WILLIAM J. SAPONE;COLEMAN SUDOL SAPONE P.C., 714 COLORADO AVENUE, BRIDGE PORT, CT, 06605, US

(73) Assignee: PER BUTTENSCHON, ESBJERG (DK)

(21) Appl. No.: 10/536,852

(22) PCT Filed: Nov. 28, 2003
(86) PCT No.: PCT/DK03/00816

§ 371 Date: Jan. 17, 2006

(30) Foreign Application Priority Data
Nov. 29, 2002 (DK) PA 2002 01846

(51) Int. Cl. F16F 1/20

(52) U.S. Cl. 267/165

(57) ABSTRACT

When according to the invention, constructing a resilient insert for a mattress or similar support of profiles (1) made of resilient resin and joining adjacent profiles along their side edges, a contiguous resilient inert will be achieved which may be disinfected by washing without being damaged. To achieve the best possible comfort, the profile (1) is formed with transverse slots (4 and 5) so that the profile may yield in an expedient manner. To carry the mattress, though-going, preferably transversely extending rods (2) are inserted into the lower side of the profiles, thereby allowing the mattress to be used without a bed bottom.

### STATE OF THE ART

The invention relates to a resilient insert for the production of a support, such as a mattress, seat and the like, which insert may be enclosed by a cover to form a finished mattress.

Inserts of this type are traditionally made of steel springs which, placed on edge, constitute the resilient insert, and which are subsequently enclosed by a cover to form the finished mattress or support.

The problem of such a mattress is that it is difficult to wash and disinfect, since it does not tolerate machine hot wash. This restricts its properties for use e.g. in hospitals, it being a problem if the mattress cannot tolerate cleaning—apart from the cover which is washable.

The hygiene requirements are so great today that mattresses must be capable of tolerating hot wash owing to the sterilization, cleaning, after use.

To meet this requirement, the steel springs must be confined in completely closed sleeves, which makes the manufacture of such mattresses both cumbersome and expensive.

To remedy this drawback, it is known to make the resilient insert of resin. An example of this is known from GB 2 055 173. The resilient insert disclosed by this document is made by extrusion in a piece of resin comprising a plurality of plane upper and lower sections which are connected by a wave-shaped intermediate member.

This prior art insert may be cleaned by hot wash, but it is vitiated by the drawback that it does not give the same comfort as is known from a spiral spring insert. The reason is the rigid profile which cannot yield sufficiently in the transverse direction, as the individual webs at the top and at the bottom cannot yield noticeably.

To this should be added that the entire insert is made by extrusion, which makes it difficult to produce inserts with zone supports of a harder type—preferably at the centre—and softer zones around. As a result, the mattress cannot be dimensioned to achieve the necessary comfort.

### OBJECTS OF THE INVENTION

The object of the invention is to remedy these defects and drawbacks, and this is achieved according to the invention when the springs are made of an elastic resin of a cross-sectional shape which at the top and at the bottom extends essentially horizontally and mutually in parallel and with a wave shape therebetween to form the resilient element, said springs being provided with transverse slots through the entire spring.

In this surprisingly simple manner it is possible to construct a resilient insert by means of such a spring which in every way gives the same comfort as spring inserts do, as the individual springs constitute an independent, movable portion between the slots in the profile.

To this should be added that it is possible to combine springs having different degrees of resilience in the individual spring elements, which allows construction of a mattress with a support which may be adapted both with respect to resilience and to position.

Finally, this mattress is fully capable of withstanding the impacts from hot wash and therefore meet every requirement made with respect to easy-to-clean and disinfectable mattresses.

When, as stated in claim 2, carriers may be inserted between the rows of spring elements, these can replace the existing mattress supports, which means that it is both easier to handle the beds and easier to clean, as bed bottoms are not necessary.

When, as stated in claim 3, the individual elements are provided with cooperating locking means along the side edges at the top and at the bottom, a mattress insert may be made by pressing adjacent elements together in the entire extent of the mattress.

When, as stated In claim 4, the elements are provided with a through-going slot and a shorter slot extending therebetween near the joints, the resilient properties will be suitably evenly distributed, and thereby the requirements of resilience and thus comfort will be met.

When, as stated in claim 5, the locking means comprise a tongue and groove joint with locking engagement, the joint may be provided simply by pressing adjacent elements together without any risk that they can subsequently be separated.

When, as stated in claim 6, the locking means are formed as pins engaging with holes, a high degree of movability and thus resilience in the longitudinal direction of the elements is achieved.

When, as stated in claim 7, part of the channel for the carrier rail extends uninterruptedly on the lower side, a suitable rigidity of the support and a good carrying capacity are achieved.

When, as stated in claim 8, the individual rows of elements are made by extrusion, a simple manufacturing process is achieved.

When, as stated in claim 9, the individual elements are made by moulding, the elements may be made with different resilient properties.

Finally, as stated in claim 10, it is expedient to join the individual elements by fusion or gluing.

### THE DRAWINGS

Examples of resilient inserts according to the invention will be described more fully below with reference to the drawing, in which

FIG. 1 shows an example of a complete insert for a mattress seen from above,

FIG. 2 shows an insert seen from above on an enlarged scale,

FIG. 3 shows an element seen in perspective with a pin joint,

FIG. 4 shows a close-up of the pin joint on an enlarged scale,

FIG. 5 shows a close-up of the channel for the carrier rail on an enlarged scale,

FIG. 6 shows an element seen in perspective with a tongue and groove joint,

FIG. 7 shows a lateral view of joined elements with a tongue and groove joint, and

FIG. 8 shows a close-up of the tongue and groove joint on an enlarged scale.

### DESCRIPTION OF EXAMPLES

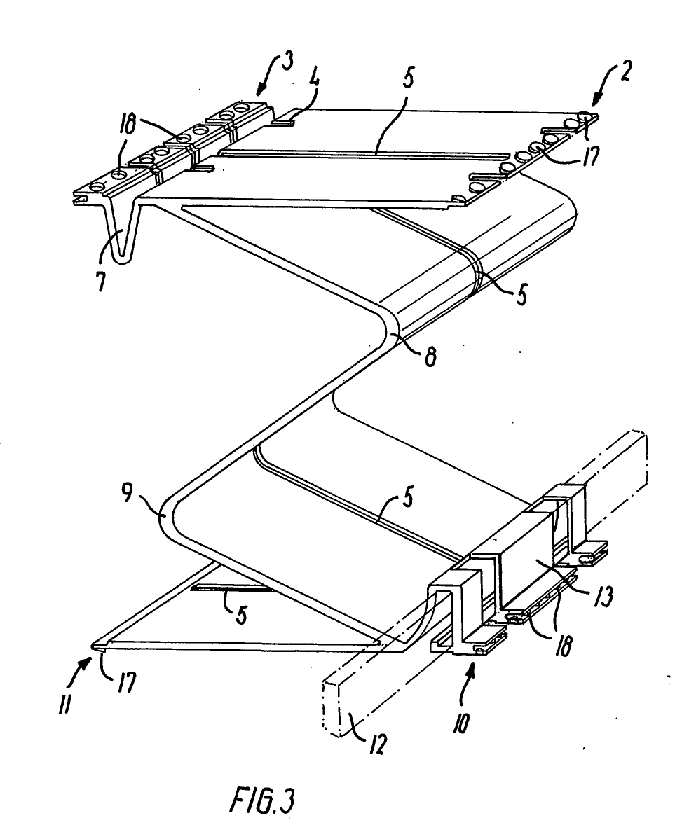

A first example of an embodiment of the resilient element is shown in FIG. 3, which is an element preferably made by moulding in sections, elements, with the appearance as shown.

The profile comprises a horizontally extending upper member with locking means along its two side edges and with a trough portion 7 between the locking means and the horizontally extending member.

A wave-shaped intermediate member extends from the trough profile, having two bending lines 8 and 9 in the example shown.

The member ends at the lower member which extends in parallel with the upper member.

The lower member is formed with a receiving section at a bend 13 which extends upwards, and which is dimensioned to receive a through-going rail 12 which preferably extends through all the elements 6 in the same row.

The rail is intended to receive the weight of the mattress and thereby replace the usual bed bottoms.

The lower portion 14, which forms the bottom of the channel; is terminated with an upwardly protruding holding rib to maintain the position of the rail 12 in the insert. This element is provided with one or more gaps 5 which extend through the entire element, apart from the outermost edge portion where the locking means are positioned.

In addition to these through-going gaps 5, short gaps 4 are moreover provided which extend essentially close to the side edge and through the locking means.

The purpose of these gaps 4, 5 is to make the element elastic in the longitudinal direction, thereby allowing the elements to absorb loads in several directions when affected from above, without the individual face members of the elements interfering with the movability of the elements.

As indicated in FIG. 3, the two resilient intermediate bends 8, 9 are made somewhat stronger in order to be able to absorb the loads to which the elements are subjected from above.

As a result, a resilient insert is achieved which has a spring force uniform in practice in the entire path of movement of the element, as is known from prior art spiral spring inserts.

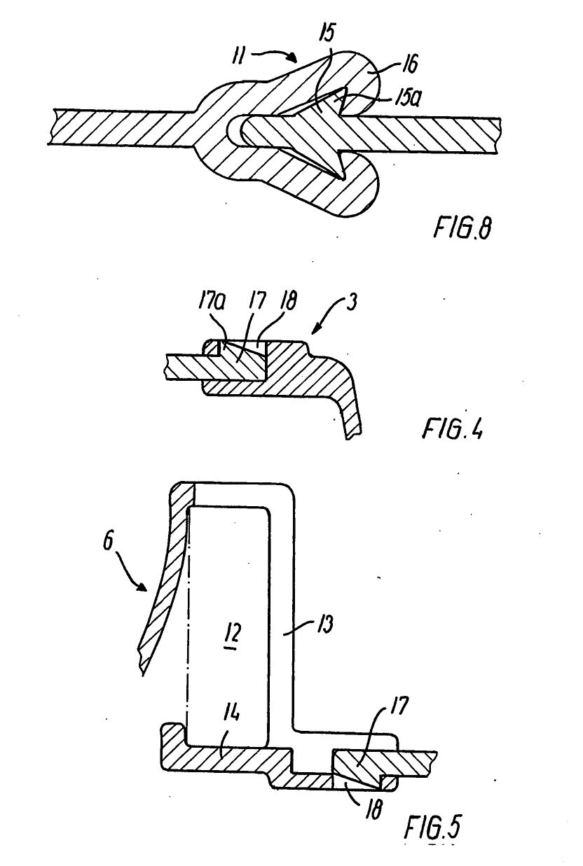

The element shown in FIG. 3 is preferably made by moulding, and it is therefore provided with locking means which will be described with reference to FIGS. 4 and 5.

FIG. 4 shows a section through the uppermost joint 3, which is on the left side in FIG. 3, and which comprises a slot facing outwards to receive the right side edge of the adjacent element.

At the top, the slot is formed with a plurality of holes 18 which constitute the receiving part for a plurality of upwardly extending pins 17 with an inclined upper side for a snap-like engagement, as shown in FIG. 3, when the parts to be joined are pushed together.

These joining means are also provided at the opposite side at the top and at both sides at the bottom corresponding to the examples shown in FIGS. 3, 4 and 5.

Adjacent elements may hereby be locked together both at the top and at the bottom to form a contiguous insert.

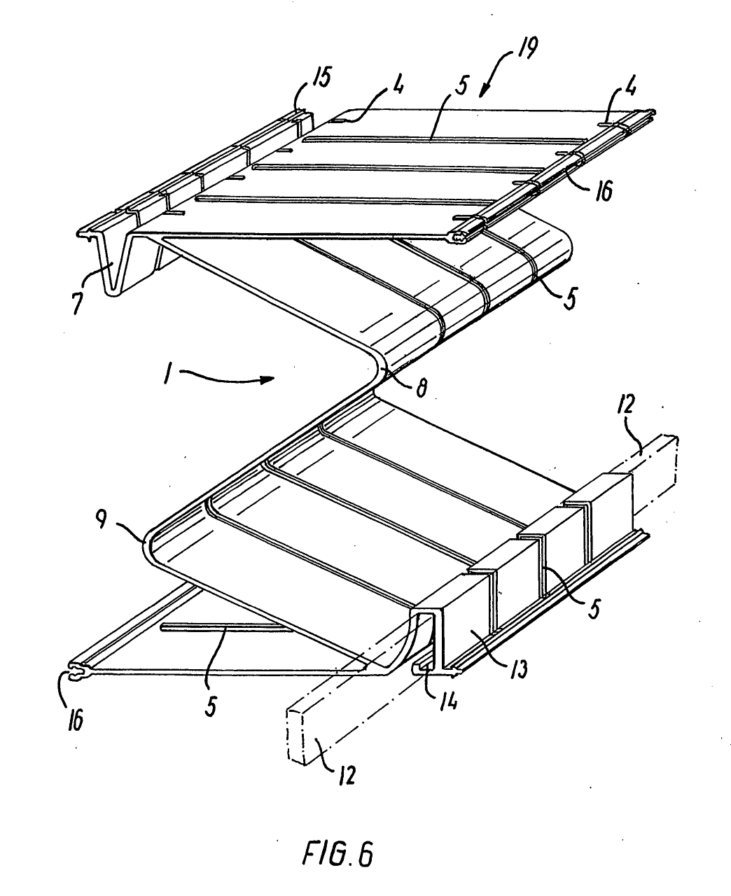

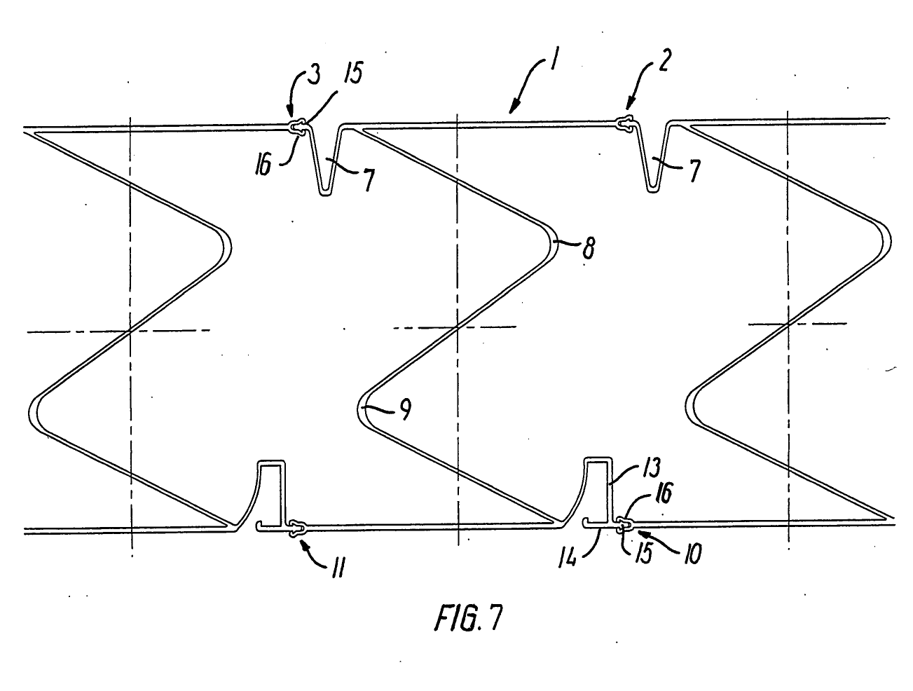

An example of an extruded element will now be described with reference to FIGS. 6 and 8.

The profile itself essentially corresponds to the profile mentioned above, except that it may be made in long webs and also be provided with other locking means.

These locking means may be configured as shown in FIG. 8 and comprise a spring 15 with hooks 15a which may be inserted into a groove 16 with cooperating hooks 16a. This locking system may be provided at the top as well as at the bottom, as indicated in FIG. 6.

Both embodiments may moreover have locking means which are recessed relative to the upper face and thereby the surface of the entire insert, as the joints 2, 3 may be level with or slightly below the surface of the insert, so that the joints cannot be felt when the mattress is used.

Instead of the locking means described, the joints may optionally be made by gluing or fusion of the locking parts.

The extent and the number of slots 4 and 5 may be varied of course according to the type of material and the dimensions of the profile. The purpose is to be able to control the recess and the spring force which are desirable to achieve the best position of rest and comfort.

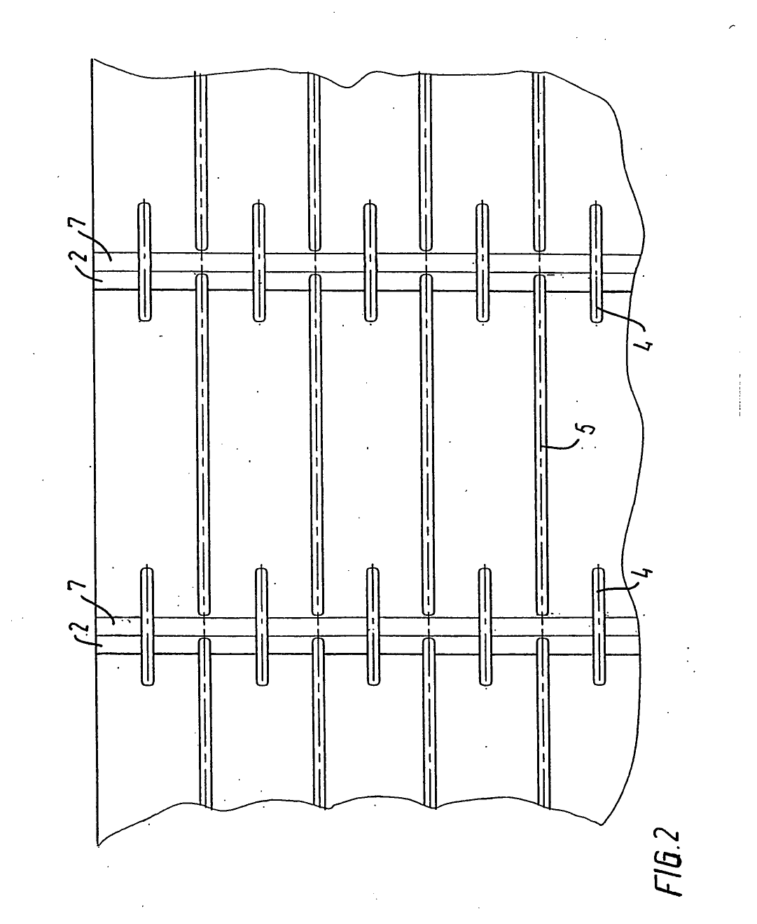

After assembly, the individual elements will appear as shown in FIG. 2. The drawing shows the uniform surface with a high degree of movability of the individual sections. This applies longitudinally because of the slots 4 and 5 as well as transversely because of the downwardly facing trough portion 7 when the joints 2 and 3 have been established.

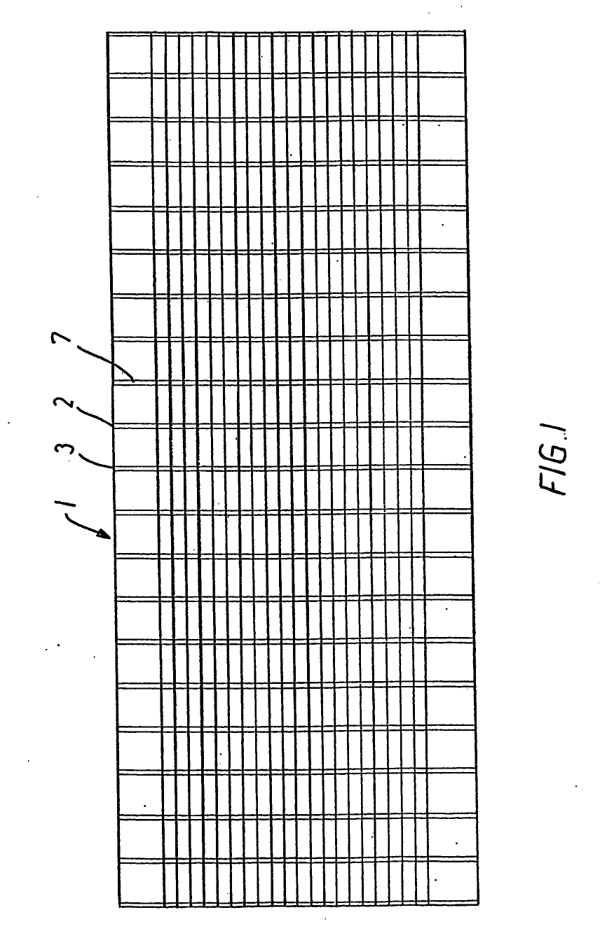

A complete insert for a mattress is shown in FIG. 1, which shows a plurality of rows 1 seen from above and held together to form the contiguous insert.

After the joining of the elements, the transverse members 12 are introduced, following which these will serve as the carrying element for the insert. Then a cover may enclose the insert, either with or without an intermediate layer to increase the softness of the surface.

Such a mattress will be suitable for running through a washing process, e.g. in a through-flow washing machine at a hot wash temperature. In use, the mattress will have the same properties as the known spring mattresses, but as mentioned, will be more hygienic in use as it can be disinfected without any adverse impact on the properties of the mattress.

1. A resilient insert for the production of a support, such as a mattress, seat and the like, which insert maybe enclosed by a cover to form a finished mattress, and where the springs are made of am elastic resin of a cross sectional shape which at the top and at the bottom extends essentially horizontally and mutually in parallel and with wave shape extending therebetween to form the resilient element, said springs being provided with transverse slots through the entire spring characterized in that the slot comprises through-going slots (5) as well as partial slots (4) extending therebetween which extend above from the side edges of the spring elements and a distance inwards.

2. A resilient insert according to claim 1, characterized in that each of the springs (1) comprises a single wave with two bending lines (8,9) to receive the vertical movability, and is provided with locking means at the top (2,3) and at the bottom (10,11) to join adjacent springs. (1) and thereby to form the complete spring insert.

3. A resilient insert according to claims 1 and 2, characterized in that a groove (7) is provided along the upper side along one side edge to receive horizontal movability.

4. A resilient insert according to claim 2, characterized in that the locking means respectively comprise a tongue and groove at each side edge at the top and at the bottom, said tongue (15) having barbs (15a) to be pressed into receiving tracks (16a) in the groove (16)

5. A resilient insert according to claim 2, characterized in that the locking means respectively comprise a plurality of upwardly facing pins (17) on the tongue to engage with a plurality of cooperating holes (18) in the groove (FIG. 4).

6. A resilient insert according to claim 2-5, characterized in that a channel (13) is provided along the lower side to receive a carrier (12) which constitutes the carrying element in the support.

7. A resilient insert according to claim 5, characterized in that the channel (13) partially encloses the rail (12) and that it is through-going uninterruptedly on the lower side (14).
